(19) United States
(12) Patent Application Publication
(10) Pub. No.: US 2002/0091732 A1
(43) Pub. Date: Jul. 11, 2002

(54) Displaying forms and content in a browser

(76) Inventor: Justin E. Pedro, Nepean (CA)

Correspondence Address: Banner & Witcoff, Ltd., 1001 G Street, N.W., Washington, DC, 20001-4597, US

(21) Appl. No.: 09/750,276

(22) Filed: Dec. 29, 2000

(51) Int. Cl. G06F 17/21

(52) U.S. Cl. 707/505

(57) ABSTRACT

The present invention relates to a system and method for presenting both forms and content in a browser. The invention includes a Java applet having a graphical user interface that receives and projects HTML content to the user. By being able to combine both forms and non-forms content in a single interface, a tighter integration of information is achieved. Further, form content is maintained during navigation though storing active forms in a workbench.

### BACKGROUND OF THE INVENTION

1. Technical Field

The invention relates to graphical user interfaces. More particularly, the invention relates to displaying forms and content in a browser.

2. Related Art

The Internet has radically changed both the content and speed at which companies disseminate information. The Internet has also provided a means by which companies can assist their clients through the use of posting relevant information on the companies' web sites. The clients later visit the web sites and retrieve and or submit information from to the companies.

The Internet has seen processing to specify and sometimes manipulate this information shift in location from being handled on the server providing a web site to the actual client computer (referred to herein as the client). One way of accomplishing scripting content for use on a client is through the use of Java.

Java applets are small programs that run in the memory of a client. Despite developers striving to provide highly integrated content between the standard HTML and Java, conventional implementations of Java and HTML force a user to use various windows and different graphical user interfaces (GUIs) as HTML and Java are not tightly integrated. For example, FIG. 1 shows how a browser (for example, Netscape from Netscape, Inc. or Internet Explorer 5.5 from the Microsoft Corporation) handles HTML and Java. As is known in the art, the browser executes on a computer system comprising a processor and a display. FIG. 1A shows incoming HTML 101 being displayed in a browser 102. FIG. 1B shows a Java applet 103 being received and run in browser 102. While Java applets contain text, they do not normally contain HTML content. Any text in an applet is generally displayed as in a window 104 separate from that of the display of the running Java applet 105. While most experienced users would not mind the opening and closing of various windows, novice users may become flustered.

Further, Java applets are dynamically run on a user's machine. Because of the failure to store persistence information relating to previous interactions with the Java applet, navigation away from then back to the Java applet will re-execute the applet thereby replacing any previously entered information.

A further problem that needs to be overcome when forms are displayed as a result of activating an HTML hyperlink is that navigating away from the form then back to the form can be difficult. If the Java form was treated as HTML content is conventionally treated, then the form may be lost in a long history of visited pages. Further, with Java applets, only one form is generally opened at a time as only one applet is normally active. Navigating to a new page or new form shuts down the previously running applet and fails to save previously entered information. FIG. 2 shows a user initiating an applet 202 from browser 201. Prior to completing the interaction with applet 202, a user may choose to navigate to new page 203 or back to page 201. Attempting to re-navigate to applet 202 may completely refresh the running of the applet and destroy all previously entered information. For long forms, a user will quickly tire of needing to reenter previously entered information

Accordingly, tighter integration between forms and content is needed.

### SUMMARY

A system and method for integrating forms and content is disclosed. By integrating both forms and content, the drawbacks of the prior art are reduced. The present invention includes a container that houses an applet that displays both forms and HTML content. In other words, the present invention displays static HTML data and dynamic Java form data in a single window. The invention permits a user to interact with a form created by a Java applet, navigate away, and have the form content maintained in the applet as the applet is not shut down. Also, as the invention maintains the content of the form with its incorporated HTML content, a user may open a new form without concern that the previous form and content will be deleted.

In one embodiment, the user may navigate static HTML hyperlinks to open new Java forms. The new form may be added to the running applet with a tab or other easy way of accessing the new form added to the graphical user interface displaying the forms. The user may navigate to HTML content from inside the running Java applet. Multiple forms may be opened simultaneously and may be accessed by tabs. In a further embodiment, an icon is displayed that, when activated, retrieves all forms and entered data. Activating the icon displays a graphical user interface that shows all open forms. The presence of this icon and its functionality assures a user that open forms and entered data may always be retrieved. By providing a way to access all open forms, the forms are not lost through a string of HTML navigations.

The invention also allows integration of HTML content and Java forms by enabling the user to open a new form by clicking an HTML hyperlink. New HTML content may also be displayed by navigating links in the displayed forms. These links or buttons may include Help buttons and the like. Activating these links or buttons redirects the applet to display the content of the HTML page associated with the button or link. In this regard, the applet is not shut down but rather the content of the new page is displayed in the applet housed by the container.

These and other aspects of the invention will be apparent from the following drawings and description.

### BRIEF DESCRIPTION OF DRAWINGS

FIGS. 1A and 1B show conventional methods of displaying content and forms in browsers.

FIG. 2 shows conventional navigation between forms and HTML pages.

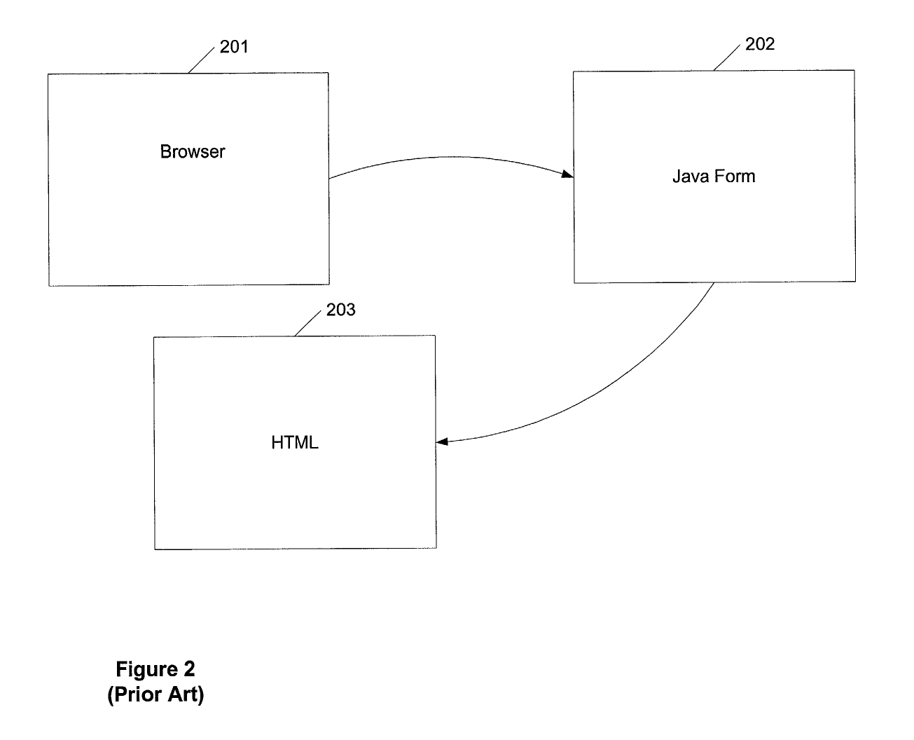

FIG. 3 shows the combination of forms and content in accordance with embodiments of the present invention.

FIG. 4 shows the display of form content in response to user input in accordance with embodiments of the present invention.

FIG. 5 shows an architecture for supporting the present invention.

FIG. 6 shows a method for performing the present invention.

### DETAILED DESCRIPTION

The present invention relates to displaying both forms and content in a common graphical user interface. The present invention may be embodied as a Java applet that, when retrieved and run in a browser, the invention displays a form or forms to a user. The Java applet is housed in a container. A container is an application program or subsystem in which the program building block known as a component is run. For example, a component—such as a button or other graphical user interface or a small calculator or database requester—may be developed using JavaBeans that can run in Netscape containers such as browsers and in Microsoft containers such as Internet Explorer, Visual Basic®, and Word.

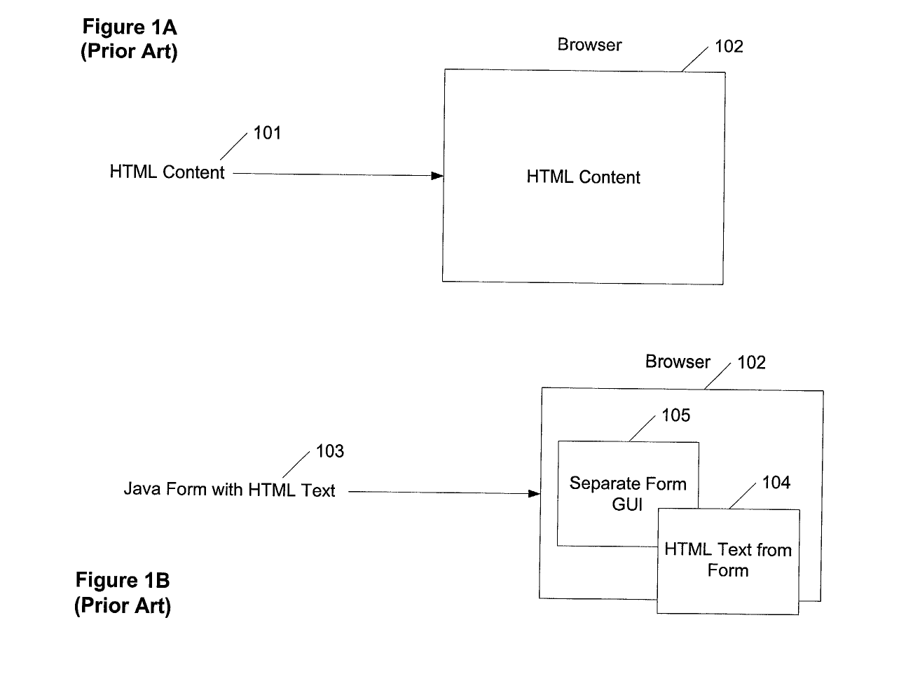

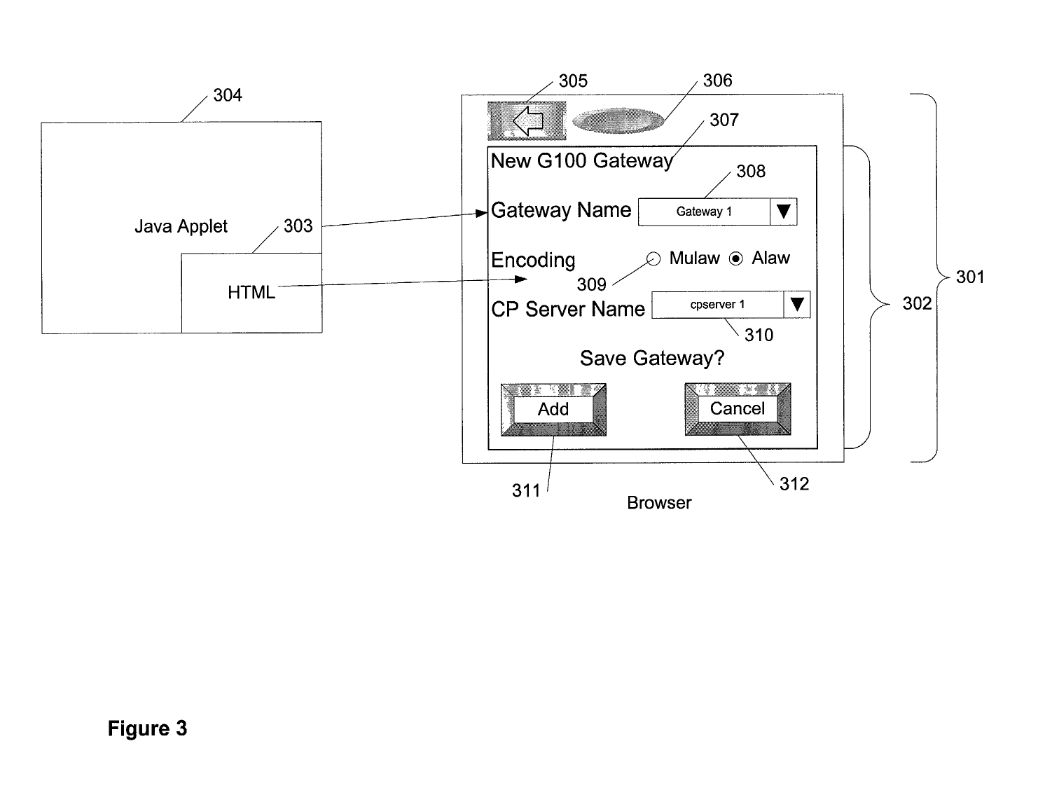

FIG. 3 shows a form displayed in accordance with embodiments of the present invention. Form 302 is a form displayed in display 301. The contents of the form 302 are generated by a Java applet 304. The applet also contains HTML information 303. This information is also displayed in form 302. The Java applet may be downloaded from the Internet, retrieved locally, or obtained by any other means of retrieving information known in the art. While FIG. 1 displays the content of a Java applet apart from the content of browser 102 as window 104, the present invention combines both the HTML content and forms content together in a display of the form.

The browser display 301 includes back button 305 and icon (or button) 306. Activation of back button 305 directs the browser to display previously displayed content. As is known in the art, as one navigates HTML pages, links to the pages are stored in a history stack (not shown for simplicity). By activating the back button 305, the browser is redirected to the top link in the history stack. The present invention includes the ability to add links to forms in the history stack.

As an example, the browser 301 displays pane 302 comprising a form. The form includes HTML text 307 and buttons 311 and 312. The form also includes form fields 308 and 310. As shown in FIG. 3, the form may be used as forms are normally used including in ordering books on-line, in e-commence in general, in configuring systems (like a system gateway for a computer system), and other form related applications as are known in the art.

The system uses Java-based classes including JEditorPane to control when a form is displayed. The form may include a variety of information as is known in the art. The system also instantiates objects from HTMLEditorKit classes to control the display of the HTML content 303 received from applet 304. Finally, the system uses HyperLinkListener to monitor for operation of hyperlinks in pane 302. While browser 301 may navigate to new content based on the activation of hyperlinks in it, operation of hyperlinks in pane 302 need to be controlled so as to not refresh the content of any dynamic forms in pane 302. This is performed by having new forms or pages displayed in the running Java applet, rather than permitting the applet to be completely replaced by the browser's redirection to new content. With the use of the applets described here, one may use conventional browsers to realize the present invention.

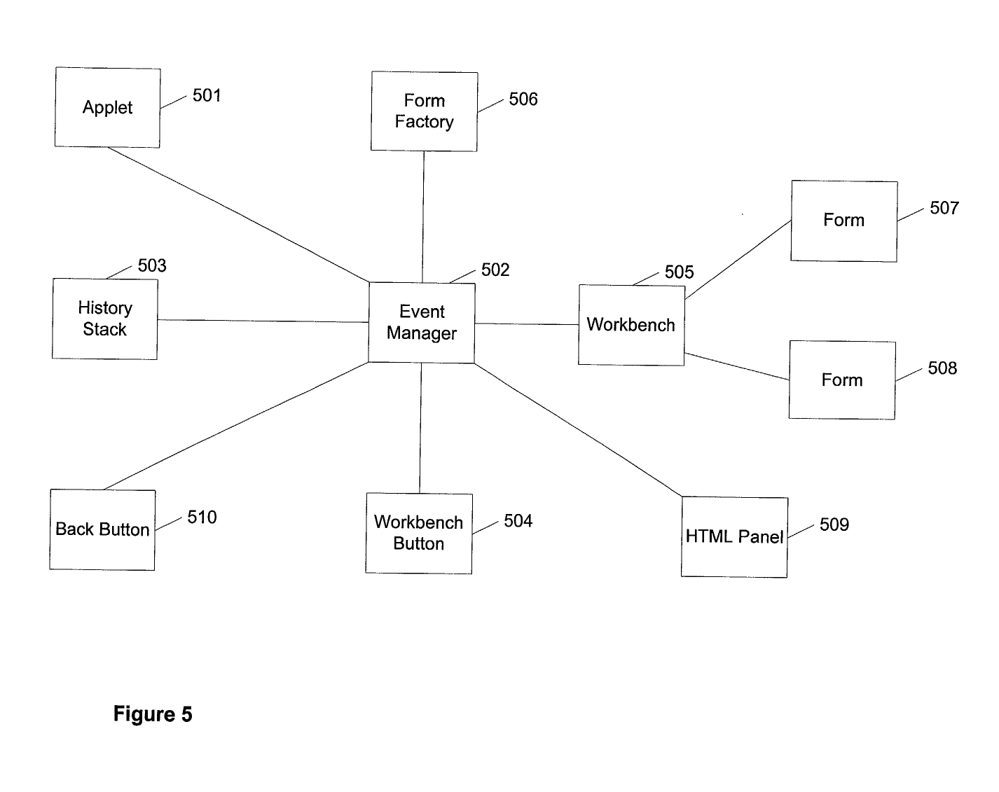

In one embodiment, the present invention displays HTML content by instantiating javax.swing.text.html.HTMLEditorKit and javax.swing.JeditorPane. The javax.swing.event.HyperlinkListener interface is implemented by the classes in the invention. The various classes are described in additional detail in respect to FIG. 5.

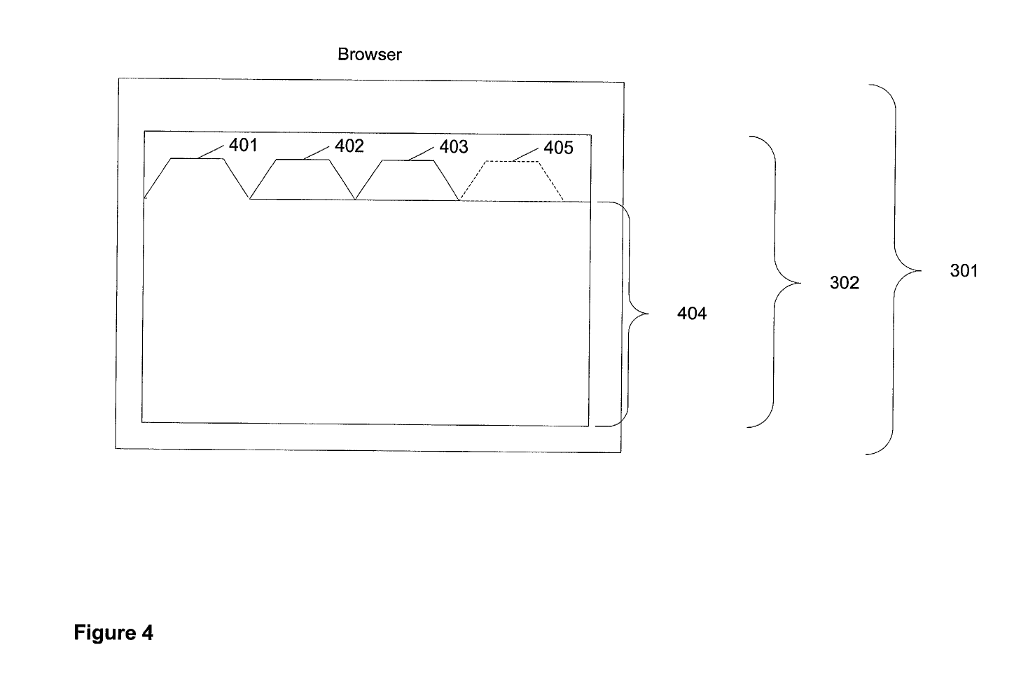

HyperEvents with the description field starting with “http:// “ cause the corresponding HTML page to be displayed in area 302. HyperlinkEvents with the description field starting with “form://” cause the container (specifically the workbench container 302 of FIG. 4) to be displayed in the browser and the corresponding form to be added as a new tab in the container 302.

The invention may be practiced using Java Developer Kit 1.2.2-001 available from Sun Microsystems, Inc. This developer kit contains the Java Runtime Environment 1.2.2-001.

FIG. 4 shows browser 301 having multiple active forms in pane 302. The forms are represented by tabs 401, 402, and 403. A new tab 405 is shown in broken lines. The contents of each tab are shown in display region 404 once the tab is selected. The content of each form, represented by tabs 401, 402, and 403, is separately maintained. Accordingly, navigation in window 404 does not refresh the currently displayed form or other forms (unless specified by, for example, navigation of a “reset” or “close” button as is known in the art). The Java forms get and set persistence information by communicating with a server process using one of the known communication protocols (for example, CORBA, RMI, or JDBC).

FIG. 5 shows an architecture for supporting the invention. Applet 501 is from a class extending javax.swing.Japplet. Event manager 502 is a class implementing java.awt.event.ActionListener. History stack 503 is a stack class extending java.util.Stack. Workbench button 504 is a short cut button that, when activated, extends javax.swing.Jbutton. The action command field of this button is set to “wb://wb”. Workbench 505 is a class extending javax.swing.JtabbedPane (resulting in the tabbed panes of FIG. 4). Form factory 506 is a factory class as is known in the art that creates forms based on a string reference in the applet. Forms 507 and 508 are form classes extending javax.swing.JPanel.

HTML Panel 509 is a class for displaying HTML content extending javax.swing.JEditoryPane with a javax.swing.text.html.HTMLEditorKit object set as the current editor kit. This class also implements javax.swing.event.HyperlinkListener.

Back Button 510 is a navigation button extending javax.swing.JButton. The action or command field of this button is set to “back://back”.

The flow of events are described as follows. All hyperlinks in the HTML content displayed in HTML Panel 509 are handled by the Panel 509. When the Panel 509 receives a javax.swing.event.HyperlinkEvent, Panel 509 creates a java.awt.event.ActionEvent with the command field of the ActionEvent set to the description of the HyperlinkEvent. Panel 509 next forwards the ActionEvent to event manager 502. Workbench 505 listens to events from controls (or buttons operable by the user) on open form objects (507 and 508). The workbench 505 may also perform some filtering by eliminating events that do not need additional action. All events that cause a new form or HTML page to become visible are forwarded to event manager 502. All other events are ignored. Finally, event manager 502 listens to events from buttons 504 and 510.

When a relevant event occurs, event manager 502 determines what action to take in response to a java.awt.event.ActionEvent by examining the command field associated with the event. If the command field starts with “wb://”, then the follow steps occur:

1) If the HTML panel 509 is visible, then it is hidden; and,

2) If the Workbench 505 is hidden, it is made visible.

If the command field starts with http://, then the following steps are taken:

1) If the HTML panel 509 is hidden, then it is made visible;

2) If the Workbench 505 is visible, it is hidden;

3) The current page of the HTML Panel is set to the command field; and,

4) A new entry is placed in stack 503 with the contents of the command field.

If the command field starts with “form://” then the following steps are taken:

1) If the HTML panel 509 is visible, then it is hidden;

2) If the Workbench 505 is hidden, it is made visible;

3) The contents of the command field are passed to form factory 506 to create a new form object (for example, 507 and 508);

4) The newly created form object is added to the workbench 505; and

5) A new entry is placed in stack 503 with the contents set to “wb://wb”.

If the command field starts with “back://”, then the following steps are taken:

1) The top entry (or other entry) of stack 503 is removed (or popped as is known in the art); and,

2) The contents of the newly removed stack entry are used to set the command field of the current ActionCommand and the ActionCommand is reprocessed.

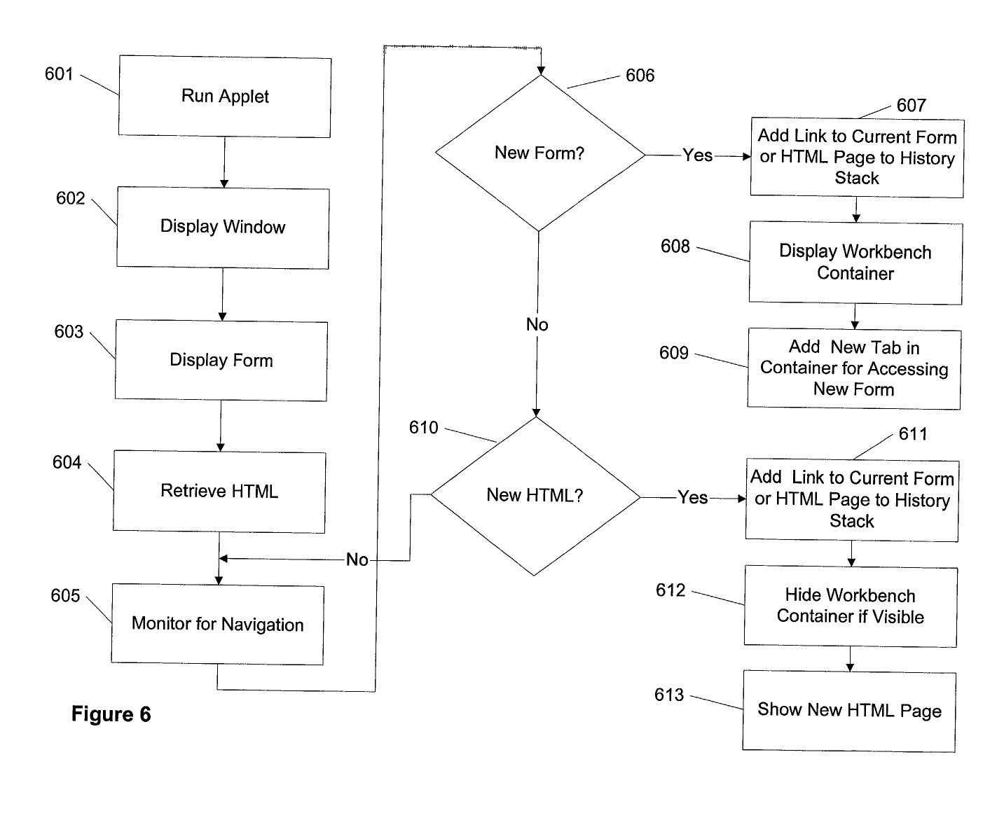

FIG. 6 shows a method of creating and navigating form content in accordance with the present invention and graphically shows the addition of a new form and HTML. In step 601, a Java applet is run. In step 602, the applet instructs a browser to open a display window and populates the window with form information, in step 603. In step 604, the Java applet retrieves HTML content and forwards the content to the browser for display in the window. In step 605, the Java applet running in the browser monitors navigation commands. These commands may take the form of events generated through selection of hyperlinks or other actions as are known in the art (including activation of buttons, icons, and the like). In step 606, the system determines if a new form is to be created. If so, the system adds a link to the currently displayed form or HTML page to the history stack (in step 607), displays the workbench container (in step 608) and adds a new tab (405) in the workbench container for accessing the new form (in step 609).

In step 610, the system determines if new HTML content is to be displayed. If so, the system adds a link to the current form or HTML page to the history stack (in step 611), hides the workbench container if visible (in step 612), and shows the new HTML page (in step 613).

Otherwise, the system continues to monitor for new actions or commands.

Various embodiments have been described. It is appreciated that various modifications of the embodiments are known to those of skill in the art and are considered within the scope of the present invention. For example, instead of using Java, one may use ActiveX controls to implement the current invention. Also, instead of using horizontally arranged tabs, one may use vertically arranged tabs. Further, one may substitute frames or a combination of frames and tabs to display forms.

The scope of the invention is intended to be limited only by the following claims.

I claim:

1. A computer with a display projecting a graphical user interface to a user, said graphical user interface displaying form content and HTML content in a common window.

2. The computer according to claim 1, wherein said graphical user interface includes tabs permitting access to said form content.

3. The computer according to claim 1, wherein said form content and said HTML content are displayed in a Java applet execution in a browser.

4. A method for displaying form content and HTML content comprising the following steps:
running a Java applet;
opening a window;
populating said window with form content generated at least by said running Java applet; and,
populating said window with HTML content.

5. The method according to claim 4, further comprising the steps of:
monitoring for an event requesting a new form;
in response to said form request event, displaying a new form in said window.

6. The method according to claim 4, further comprising the steps of:
monitoring for an event requesting new HTML content;
in response to said HTML content request event, displaying new HTML content in said window.

7. A method for navigating a user interface having a back button and a button designating a collection of open forms, comprising the steps of:
receiving a user selection of one of said back button or said button designating said collection;
determining which button was selected;
if said back button was selected, then reprocessing a command field of an entry in a history stack and
if said button designating said collection of open forms was selected, then opening said collection of forms in a window.

8. The method according to claim 7, wherein the user interface includes a region permitting the creation of another form, said method further comprising the steps of:
receiving a request for a new form;
creating said new form;
adding said new form to said collection of forms;
adding an entry in said history stack pointing to said new form.

9. A system for displaying forms and HTML content comprising:
a display displaying a graphical user interface having at least one window;
a processor running a browser program and outputting information to said display;
wherein said processor receives form content from a Java applet and HTML content from said Java applet, combines said form content and said HTML content in a browser program and outputs the combined content to said display.

10. The system according to claim 9, wherein said Java applet presents said form content in a window with tabs permitting selection of said form content.

11. The system according to claim 9, wherein said Java applet includes handling of activation of a back button.
